(19) United States
(12) Patent Application Publication
(10) Pub. No.: US 2022/0245476 A1
(43) Pub. Date: Aug. 4, 2022

(54) AUTOMATICALLY GENERATING ASSERTIONS AND INSIGHTS

(71) Applicant: Asserts Inc., San Ramon, CA (US)

(72) Inventors: Manoj Acharya, Pleasanton, CA (US); Jia Xu, Tiburon, CA (US); Jim Gehrett, Larkspur, CA (US)

(73) Assignee: Asserts Inc., San Ramon, CA (US)

(21) Appl. No.: 17/339,988

(22) Filed: Jun. 5, 2021

Related U.S. Application Data
(63) Continuation-in-part of application No. 17/339,985, filed on Jun. 5, 2021.
(60) Provisional application No. 63/144,982, filed on Feb. 3, 2021.

(51) Int. Cl. G06N 5/02; G06N 5/04

(52) U.S. Cl. CPC G06N 5/027; G06N 5/043

(57) ABSTRACT

A system monitors an application and automatically models, correlates, and presents insights. The monitoring is performed without requiring administrators to manually identify what portions of the application should be monitored. The modeling and correlating are performed using a knowledge graph and automated modeling system that identifies system entities, builds the knowledge graph, and reports the most crucial insights, determined automatically, using a dashboard that automatically reports on the most relevant system data and status.

### CROSS REFERENCE TO RELATED APPLICATIONS

The present application is a continuation-in-part of patent application Ser. No. 17/339,985, filed on Jun. 5, 2021, titled “AUTOMATICALLY GENERATING AN APPLICATION KNOWLEDGE GRAPH,” which claims the priority benefit of U.S. provisional patent application 63/144,982, filed on Feb. 3, 2021, titled “AUTOMATICALLY GENERATING AN APPLICATION KNOWLEDGE GRAPH,” the disclosures of which are incorporated herein by reference.

### BACKGROUND

Application monitoring systems can operate to monitor applications that provide a service over the Internet. Typically, the administrator of the operating application provides specific information about the application to administrators of the monitoring system. The specific information indicates exactly what portions of the application to monitor. The specific information is static, in that it cannot be changed, and the monitoring system has no intelligence as to why it is monitoring a specific portion of a service. What is needed is an improved system for monitoring applications.

### SUMMARY

The present technology, roughly described, monitors an application and automatically models, correlates, and presents insights. The monitoring is performed without requiring administrators to manually identify what portions of the application should be monitored. The modeling and correlating are performed using a knowledge graph and automated modeling system that identifies system entities, builds the knowledge graph, and reports the most crucial insights, determined automatically, using a dashboard that automatically reports on the most relevant system data and status.

The present system is flexible in that it can be deployed in several different environments having different operating parameters and nomenclature. A system graph is created from the nodes and metrics of each environment application that make up a client system. The system graph, and the properties of entities within the graph, can be displayed through an interface to a user. Assertion rules are generated, both by default and after monitoring an application, and used to determine the status and health of a system. If assertion rules experience a failure, data regarding the failure is automatically reported. The system architecture may be reported through a dashboard that automatically provides insights regarding the system components and areas of concern.

In some instances, a method may automatically generate and apply assertions. The method can begin with receiving a first set of time series metrics with labels from one or more agents monitoring a client system in one or more computing environments. The method can continue with automatically applying a set of rules to the time series metrics. Next, a knowledge graph generated from the time series metrics can be automatically updated. One or more assertions can then be automatically generated based on time series metrics and the result of applying the rules, wherein the results of applying the rules used to update the knowledge graph. The assertions can automatically be reported though a user interface.

In some instances, a system for automatically generating and applying assertions can include a memory and a processor. One or more modules stored in the memory can be executed by the processor to receive a first set of time series metrics with labels from one or more agents monitoring a client system in one or more computing environments, automatically apply a set of rules to the time series metrics, automatically update a knowledge graph generated from the time series metrics, automatically generate one or more assertions based on time series metrics and the result of applying the rules, the results of applying the rules used to update the knowledge graph, and automatically report the assertions though a user interface.

### BRIEF DESCRIPTION OF FIGURES

FIG. 1 is a block diagram of a system for monitoring a cloud service.

FIG. 2 is a block diagram of an application for automatically and dynamically generating assertions and providing insights.

FIG. 3 is a block diagram of an application for automatically and dynamically generating assertions.

FIG. 4 is a method for automatically generating insights based on assertions.

FIG. 5 is a method for automatically applying a list of assertion rules to TS metric data.

FIG. 6 is a method for reporting processed system metric data through an interface.

FIG. 7 illustrates a user interface providing a node graph for reporting the status of a cloud service system.

FIG. 8 illustrates a user interface for reporting metrics of an entity within a cloud service system.

FIG. 9 illustrates a user interface for providing a node graph for selected entities within a cloud service system.

FIG. 10 illustrates properties provided for a selected node in a node graph for a monitored system.

FIG. 11 illustrates an entity within a node within a node graph for a monitored system.

FIG. 12 illustrates a selection of additional entities for a node within a node graph for a monitored system.

FIG. 13 illustrates assertions for entities within a node within a node graph for a monitored system.

FIG. 14 illustrates a timeline for a node within a monitored system.

FIG. 15 illustrates a computing environment for implementing the present technology.

### DETAILED DESCRIPTION

The present system monitors an application and automatically models, correlates, and presents insights. The monitoring is performed without requiring administrators to manually identify what portions of the application should be monitored. The modeling and correlating are performed using a knowledge graph and automated modeling system that identifies system entities, builds the knowledge graph, and reports the most crucial insights, determined automatically, using a dashboard that automatically reports on the most relevant system data and status.

The present system is flexible in that it can be deployed in several different environments having different operating parameters and nomenclature. A system graph is created from the nodes and metrics of each environment application that make up a client system. The system graph, and the properties of entities within the graph, can be displayed through an interface to a user. Assertation rules are generated, both by default and after monitoring an application, and used to determine the status and health of a system. If assertion rules experience a failure, data regarding the failure is automatically reported. The system architecture may be reported through a dashboard that automatically provides insights regarding the system components and areas of concern.

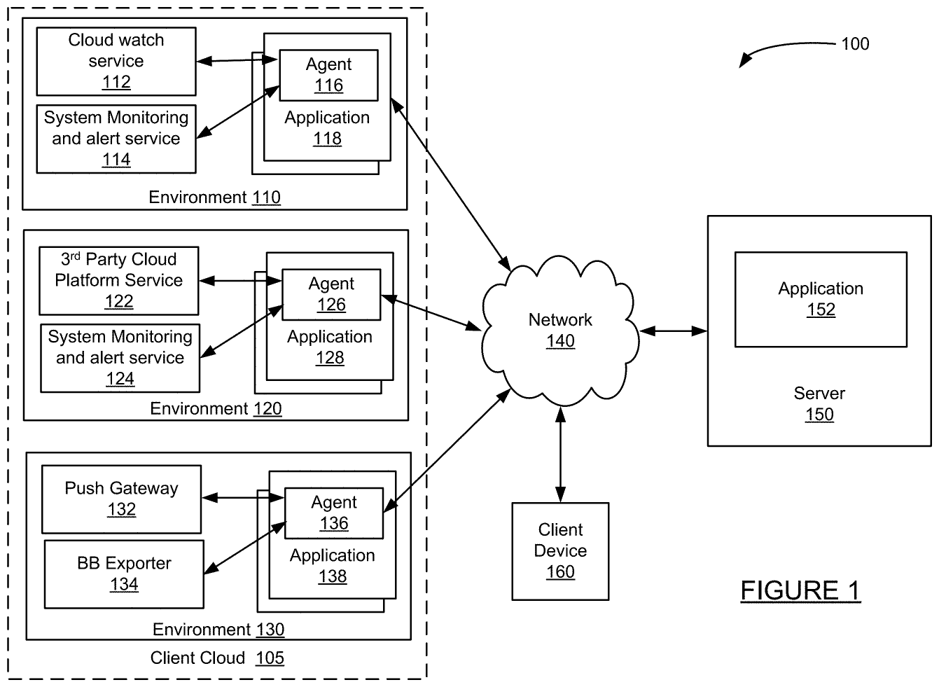

FIG. 1 is a block diagram of a system for monitoring a cloud service and automatically generating assertions. The system of FIG. 1 includes client cloud 105, network 140, and server 150. Client cloud 105 includes environment 110, environment 120, and environment 130. Each of environments 110-130 may be provided by one or more cloud computing services, such as a company that provides computing resources over network. Examples of a cloud computing service include “Amazon Web Service” by Amazon, Inc. and “Google Cloud Platform,” Google, Inc., and “Azure” by Microsoft, Inc. Environment 110, for example, includes cloud watch service 112, system monitoring and alert service 114, and client application 118. Cloud watch service 112 may be a service provided by the cloud computing provider of environment 110 that provides data and metrics based on events associated with an application executing in environment 110, as well as the status of resources in environment 110. System monitoring and alert service 114 may include a third-party service that provides monitoring and alerts for an environment. An example of a system monitoring and alert service 114 includes “Prometheus,” an open source software application used for event monitoring and alerting.

Client application 118 may be implemented as one or more applications on one or more machines that implement a system to be monitored. The system may exist in one or more environments, for example environments 110, 120, and/or 130.

Agent 116 may be installed in one or more client applications within environment 110 to automatically monitor the client application, detect metrics and events associated with client application 118, and communicate with the system application 152 executing remotely on server 150. Agent 116 may detect new data (i.e., knowledge) about client application 118, aggregate the data, and store and transmit the aggregated data to server 150. Client application 118 may automatically perform the detection, aggregation, storage, and transmission based on one or more files, such as a rule configuration file. Agent 116 may be installed with an initial rule configuration file and may subsequently receive updated rule configuration files as the system automatically learns about the application being monitored.

Environment 120 may include a third-party cloud platform service 122 and a system monitoring and alert service 124, as well as client application 128. Agent 126 may execute on client application 128. The system monitoring alert service 124, client application 128, and agent 126 may be similar to those of environment 110. In particular, agent 126 may monitor the third-party cloud platform service, application 128, and system monitoring and alert service, and report to application 152 on system server 150. The third-party cloud platform service may provide environment 120, including one or more servers, memory, nodes, and other aspects of a “cloud.”

Environment 130 may include client application 138 and agent 136, similar to environments 110 and 120. In particular, agent 136 may monitor the cloud components and client application 138, and report to application 152 on server 150. Environment 130 may also include a push gateway 132 and BB exporter 134 that communicate with agent 136. The push gateway and BB exporter may be used to process batch jobs or other specified functionality.

Network 140 may include one or more private networks, public networks, local area networks, wide-area networks, an intranet, the Internet, wireless networks, wired networks, cellular networks, plain old telephone service networks, and other network suitable for communicating data. Network 140 may provide an infrastructure that allows agents 116, 126, and 136 to communicate with application 152.

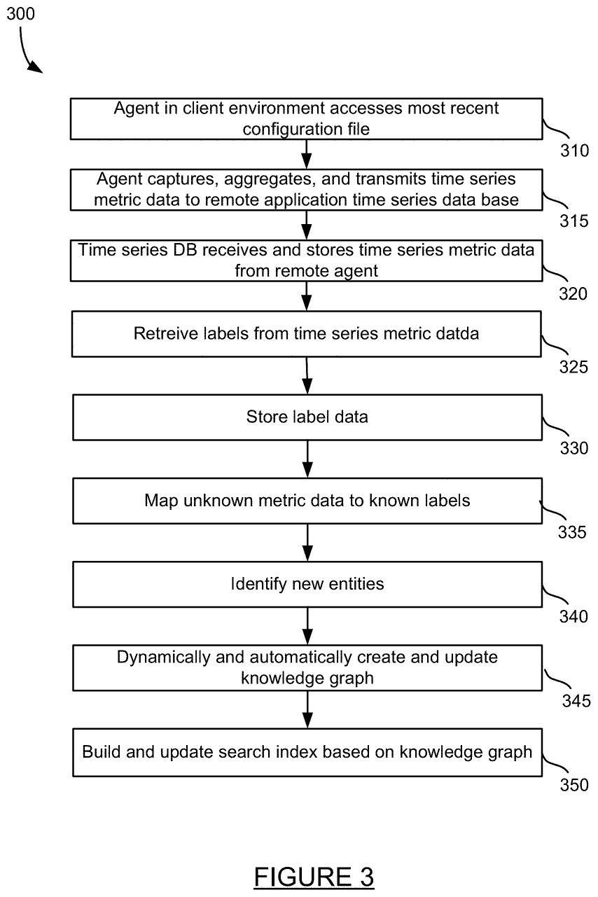

Server 150 may include one or more servers that communicate with agents 116, 126 and 136 over network 140. Application 152 can be stored on and executed by a single server 150 or distributed over on one or more servers. In some instances, application 152 may execute on one or more servers 150 in an environment provided by a cloud computing provider. Application 152 may receive data from agent s 116, 126, and 136, process the data, and model, correlate, and present insights for the data based at least in part on assertion rules and a knowledge graph. Application 152 is described in more detail with respect to FIG. 3.

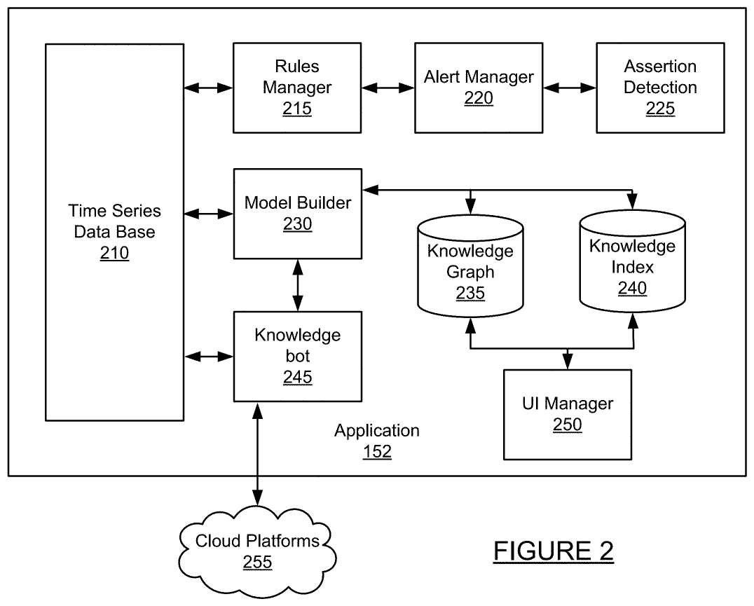

FIG. 2 is a block diagram of an application for automatically and dynamically generating assertions and providing insights. The application 200 of FIG. 2 provides more detail for application 152 on server 150 of FIG. 1. Application 200 includes timeseries database 210, rules manager 215, alert manager 220, assertion detection 225, model builder 230, knowledge graph 235, knowledge index 240, UI manager 250, and knowledge bot 245. Each of the modules 210-245 may perform functionality as described herein. Application 200 may include additional or fewer modules, and each module may be implemented with one or more actual modules, located on a single application, or distributed over several applications or servers. Additionally, each module may communicate with each other, regardless of the lines of communication illustrated in FIG. 2.

Timeseries database 210 may reside within application 200 or be implemented as a separate application. In some instances, timeseries database 210 may be implemented on a machine other than server 150. Timeseries database may receive timeseries metric data from agents 116-136 and store the time series data. Timeseries database 210 may also perform searches or queries against the data, insert new data, and retrieve data as requested by other modules or other components.

Rules manager 215 may update a rules configuration file that is maintained on server 150 and transmitted to one or more of agents 116-126, and 136. The rules manager may maintain an up-to-date rules configuration file for a particular type of environment, provide the updated rules configuration file with agent modules being installed in a particular environment, and update rule configuration files for a particular agent based on data and metrics that the agent is providing to application 152. In some instances, rules manager 215 may periodically query timeseries database 210 for new data or knowledge received by agent 116 as part of monitoring a particular client application. When rules manager 215 detects new data, the rule configuration file is updated to reflect the new data.

Alert manager 220 managers alerts for application 152. In some instances, if an assertion rule failure occurs, alert manager 220 may generate failure information for the particular node or entity associated with the failure. The failure may be indicated in the call graph, as well as in a dashboard provided by UI manager 250. In some instances, the alert manager generates a failure that is depicted as red or yellow ring, based on the severity of the failure, around the node or entity for which the failure is detected. Alert manager 220 can also create alerts for displaying on a dashboard provided by UI manager 250 and communications with an administrator.

Assertion detection engine 225 can define assertion rules and evaluate the rules against timeseries data within the database 210. The assertion detection engine 225 applies rules to metric data, or a particular system, and identifies portions of the data that fail the rules. The failings are then recorded in the graph as attachments to entities. The assertion role definitions may include saturation of a resources, anomalies, changes to code whether amendments, failures and faults, and KPIs such as error ratio or error budget.

Assertion rules can be generated in several ways. In some instances, rules are generated automatically based on metrics. For instance, the assertion engine 225 may determine a particular rate of a request over a time period, and generate rules based on a baseline observed during that time period. For example, the assertion engine may observe that three errors that occur in two minutes, and use that as a baseline. As time goes on while monitoring the system, the baselines may be updated over larger periods of time, and additional baselines may be determined (e.g., short term and long term baselines). Some of the rules determined automatically include connections over time, output bytes, input bites, latency total, and error totals.

Some assertions may be determined automatically based on assertion rules with failures. For example, if assertion detection 225 determines that a particular pod in a Kubemetes system executes a function with a very long response time that amounts to an anomaly, an assertion rule may be automatically generated for the particular pod in the particular system and for the particular metric. The assertion rule may be automatically generated by the rules manager, for example in response to receiving an alert regarding the pod response time anomaly from the alert manager.

When rules are triggered, a call is placed to the assertion engine by the rules manager. The assertion engine can then process the rules, identify the assertion rules that experience any failures, and update the entity/knowledge graph accordingly to reflect the failures. The knowledge graph can be updated, for example, to indicate that one or more components of a node have experienced a particular failure during a particular period of time for a particular client system.

Model builder 230 may build and maintain a model, in the form of a knowledge graph, of the system being monitored by one or more agents. The model built by model builder 230 may indicate system nodes, pods, services, relationships between nodes, node and pod properties, system properties, and other data. Model builder 230 may consistently update the model based on data received from timeseries database 210, including the status of each component with respect to application of one or more assertion rules for each component. For example, model builder 230 can scan, periodically or based on some other event, time-series metrics and their labels to discover new entities, relationships, and update existing entities along with their properties and status. A searchable knowledge index may be generated from the knowledge graph generated by the module builder, and enable queries on the scanned data and for generating and viewing snapshots of the entities, relationships, and their status in the present and arbitrary time windows at different points in the time. In some embodiments, schema .yml files can be used to describe entities and relationships for the model builder.

An example of model schema example snippets, for purpose of illustration, are below:

### Source: Graph

type: HOSTS
startEntityType: Node
endEntityType: Pod
   definedBy:
source: ENTITY MATCH
matchOp: EQUALS
startPropertyLabel: name
endPropertyLabel: node
staticProperties:
   cardinality: OneToMany

### Source: Metrics

type: CALLS
startEntityType: Service
endEntityType: KubeService
   definedBy:
source: METRICS
pattern: group by (job, exported_service) (nginx_ingress_controller_requests)
startEntityNameLabels: [“job”]
endEntityNameLabels: [“exported_service”]

Knowledge graph 225 knowledge graph) may be built based on the model generated by model builder 230. In particular, the cloud knowledge graph can specify node types, relationships, and properties for nodes in a system being monitored by agents 116-136. The cloud knowledge graph is constructed automatically based on data written to the time series database and the model built by model builder 220.

A knowledge index 240 may be generated as a searchable index of the cloud knowledge graph. The knowledge index is automatically built from the graph, and creates new expressions dynamically from templates in response to a new domain or error detection. Searchable entities within the knowledge index include pods, service, nodes, service instance, kafka topic, Kubernetes entity, Kubernetes service, namespace, node group, and other aspects of a system being monitored and the associated knowledge graph. The cloud knowledge index includes relationships and nodes associated with search terms. When a search is requested by a user of the system, the cloud knowledge index is used to determine the entities for which data should be provided in response to the search.

Knowledge bot 235 may detect new data in timeseries database 210. The new knowledge, such as new metrics, event data, or other timeseries data, may be provided to rules manager 215, model builder 220, and other modules. In some instances, knowledge bot scrapes cloud providers for the most up-to-date data for static components, and connects the data to scraped data in order to build insights from the connected data. In some instances, knowledge bot 235 may be implemented within timeseries database 210. In some instances, knowledge bot 235 may be implemented as its own module or as part of another module.

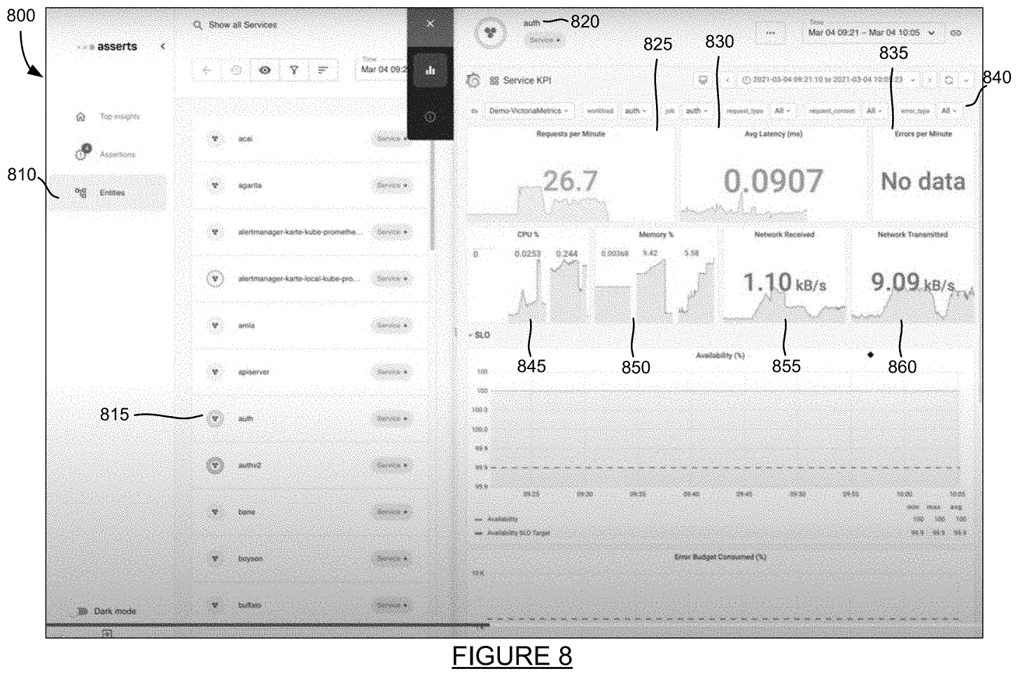

GUI manager 240 may manage a graphical user interface provided to a user. The GUI may reflect the cloud knowledge graph, provide assertions and current status, timelines, lists of nodes within a system, and may include system nodes, node relationships, node properties, and other data, as well as one or more dashboards for data requested by a user. Examples of interfaces provided by GUI manager 240 are discussed with respect to FIGS. 8-14.

FIG. 3 is a method for monitoring a cloud service. The agent in a client environment accesses a configuration file at step 310. Initially, an agent may load an initial or default rule configuration file. Updated rule configuration files may then be provided to agent over time, for example from a rules manager or other component or module of application 152. The rule configuration file may be constructed for the particular environment 110, resources being used by application 118, and based on other parameters.

Metric label and event data can be captured, aggregated, and transmitted to a remote application time series data base at step 315. The metric label and event data can be retrieved periodically at a client machine based on the rule configuration file. Retrieving metric, label, and event data may include an agent accessing rules and retrieving the data from a client application or environment by the agent based on the received rules. In some instances, the agent may automatically transform or rewrite the existing metric label data into a specified nomenclature which allows the metrics to be aggregated and reported more easily. The data may be aggregated and cached locally by the agent until it is transmitted to application 152 to be stored in a timeseries database. The caching and time at which the data is transmitted is set forth with the data configuration file.

The timeseries database receives and stores the timeseries metric data sent by the remote agent at step 320. Labels are retrieved from the timeseries metric data at the application by the server at step three 225 and a label data is stored at step 330. Unknown metric data may be mapped to known labels at step 335 and new identities may be identified at step 340. A knowledge graph is dynamically and automatically created and updated at step 345. A search index based on the knowledge graph is then automatically built in updated at step 350.

More details for installing an agent, collecting data, transmitting data by an agent to a remote application, and building a knowledge graph is discussed with respect to U.S. patent application Ser. No. ______, titled “XX,” filed on Apr. _, 2021, the disclosure of which is incorporated herein by reference.

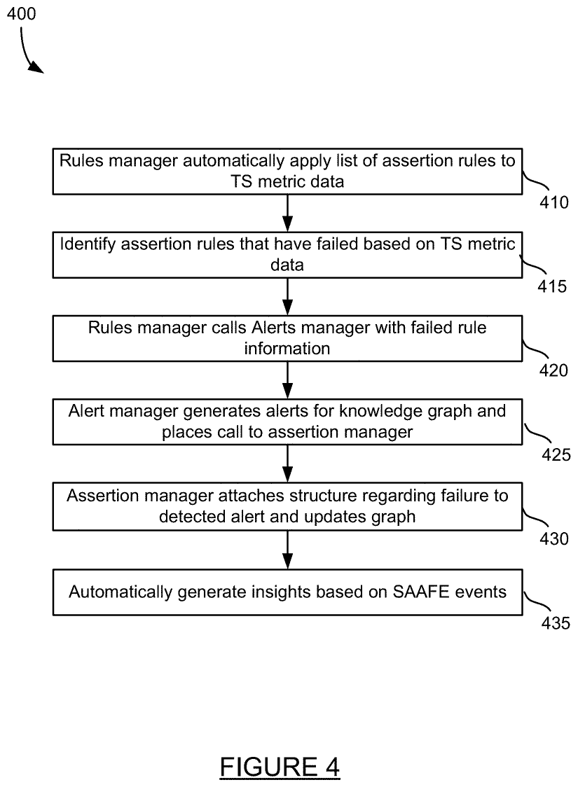

FIG. 4 is a method for automatically generating insights based on assertions. First, a rules manager automatically applies a list of assertion rules to stored timeseries metric data at step 410. The rules may be automatically generated and based on different parameters, such as for example saturation, an anomaly, amendments, failures and faults, and error ratio and error budget.

Assertion rules that have failed based on the timeseries metric data are identified at step 415. For example, if a particular memory allocation has been saturated, this would result in a failure of the particular assertion rules. This failure of the resource saturation would be identified at step 415.

A rules manager calls an alert manager with assertion rule failure information at step 420. For each rule failure, alert data is created by the alerts manager at step 420. The alert may include an update or additional data to include in a knowledge graph, graphics to include in a dashboard, a notification to transmit to an administrator, or some other implementation of an alert. The alert manager generates alerts for a knowledge graph and places calls to an assertion manager at step 425. The assertion manager attaches a structure regarding the failure to the detected alert and updates to the knowledge graph at step 430. Next, insights are automatically generated based on particular events at step 435. The insights may include failures and important status information for portions of the system that fail one or more assertion model rules for saturation, an anomaly, amendments, failures and faults, and error ratio, error budget, and other kpi elements.

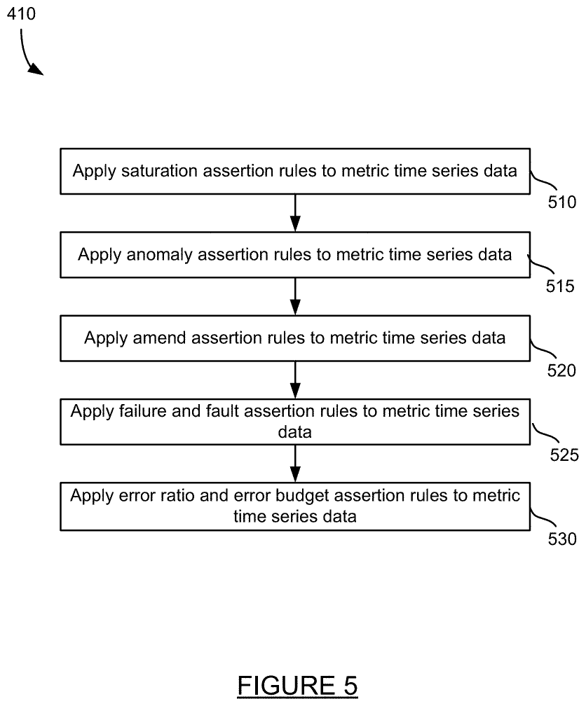

FIG. 5 is a method for automatically applying a list of assertion rules to TS metric data. The method of FIG. 5 provides more detail for step 410 of the method of FIG. 4. Saturation assertion rules are applied to the metric timeseries data at step 510. Saturation assertion rules are related to saturation of a particular resource, such as available memory, processors, or other resources. An anomaly assertion rules applied to metric timeseries data at step 515. An anomaly assertion role may relate to a metric value having a value that is an anomaly from a typical value, such as request rate or latency.

An amend assertion role is applied to metric timeseries data at step 520. An amend assertion role can be applied to amendments or changes to code, such as updated code, replacement code, or other changes to code. A failure and fault assertion rule may be applied to metric timeseries data at step 525. The failure and faults may relate to failures and faults that are triggered during code execution.

Error ratio and error budget assertion rules may be applied to metric timeseries data at step 530. Error ratio and error budget are examples of key performance indicators that may be tracked for a particular system. Assertion rules may be generated for other key performance indicators “KPIs” as well.

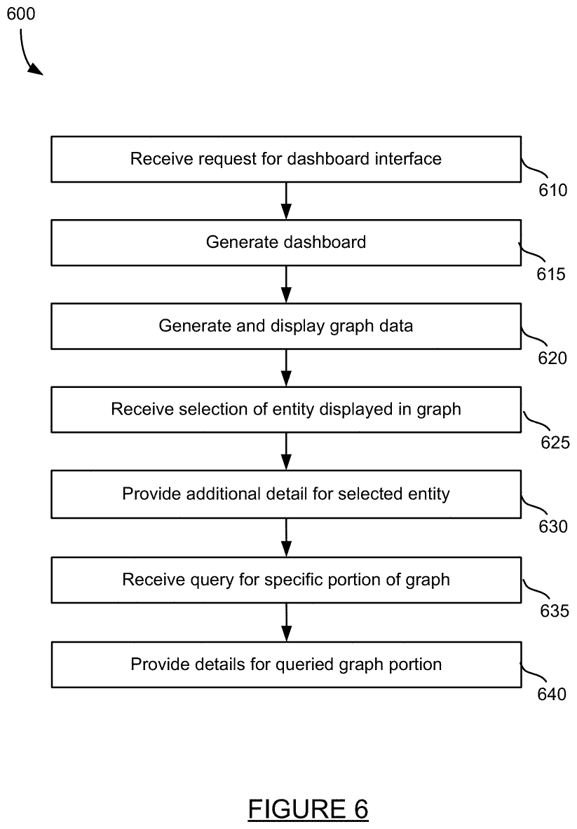

FIG. 6 is a method for reporting processed system metric data through an interface. The method of FIG. 6 begins with receiving a request for a dashboard interface at step 610. The request may be received over network from administrative device in communication with server 150. A dashboard may be generated at step 615. The dashboard may include graphs, lists, timelines, assertions, insights, and other data generated automatically by application 152. Examples of dashboards are illustrated with respect to FIGS. 8-14. Display graph data may be generated and displayed within the dashboard at step 620. The display graph data may be retrieved from a call graph, and include entity information, the results of the assertions, and other data.

A selection of an entity displayed in a graph may be received at step 625. Additional detail made them be provided for the selected entity at step 630. Additional detail may include other nodes, pods, or other components which comprise the selected entity or have relationships with the selected entity. In some instances, additional detail may also include properties or other data associated with a selected entity.

A query may be received for a specific portion of a graph at step 635. In some instances, an administrator may only wish to view a particular node, particular type of note, or some other subset of the set of nodes within a system. In response to receiving the query, the system may provide the query graph portion as well as additional details, such as properties, in a dashboard at step 640.

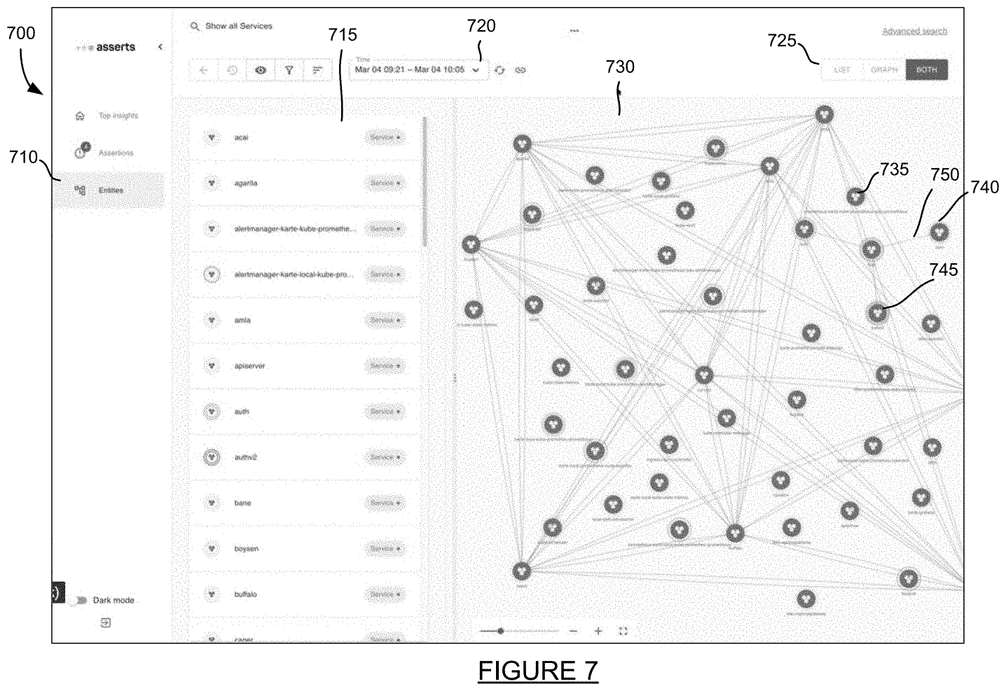

FIG. 7 illustrates a user interface providing a node graph for reporting the status of a cloud service system. The interface 700 of FIG. 7 provides a dashboard for providing a list and graph to a user for a monitored system. The dashboard shows that a display of entities 710 is currently selected for display. The dashboard includes a list 715 as well as a graph 730, as indicated by a selection bar 725. The time for the particular data is listed as March 4 from 921 through March 4 at 1005 per time selection bar 720.

The list 715 includes information for multiple entities, including an indication that each entity is a service, the service name, and a graphical icon indicating the status.

Each icon representing an entity or service provides an inner icon surrounded by status indicators. The inner icon may be implemented as a circle or some other icon or graphical component. The status indicators may be provided as one or more rings, wherein each ring represents one or more entities or subcomponents and their status. When a subcomponent is associated with one or more failures, the status indicator for that subcomponent may visually indicate the failure, for example by having a color or red. When a subcomponent is associated with a near failure, the status indicator for that subcomponent may be yellow. When a subcomponent is operating as expected with no failures, the status indicator for that subcomponent may be gray, green, or some other color. In some instances, icons for a particular entity having multiple subcomponents may have multiple rings.

Within graph portion 730, nodes 735, 740, and 745 are all represented amongst other nodes. Each node includes a center icon and one or more status indicator rings. Each node also includes at least one relationship connector 750 between that node and other nodes. For example, node 740 includes at least one yellow status indicator ring and node 745 includes at least one red status indicator ring.

FIG. 8 illustrates a user interface for reporting metrics of an entity within a cloud service system. Interface 800 provides a dashboard showing information for entities a 10. In particular, an entity of “auth” is selected within a list, and metrics are provided for that selected entity.

The metric window for the selected entity includes parameter data that is selected by the user. The parameter data 840 indicates user selections for workload “auth”, job “auth”, request type “all”, and error type “all.” The metrics provided for the selected entity may be displayed based on several types of parameters, such as those shown in parameter bar a 40, as well as filters. Different parameters and filters may be used to this modify the display of metrics for the selected entity.

The selected entity, as illustrated by entity name 820, includes displayed metrics of requests per minute window 825, average latency window 830, errors per minute window 835, CPU percentage window sure window 845, memory percentage 850, network received window 855, and network transmitted window 860. For each displayed metric 825-860, the status of the metric with respect to an assertion rule is indicated by the color of the data within the particular window. For example, errors per minutes CPU percentage, and memory percentage are green, indicating the values of those metrics are good. The color for the request per minute metric and average latency metric are yellow, indicating they are close to violating an assertion rule. The networks received metric and network transmitted metric are both colored red, indicating the time series data for these metrics violates the assertion rule.

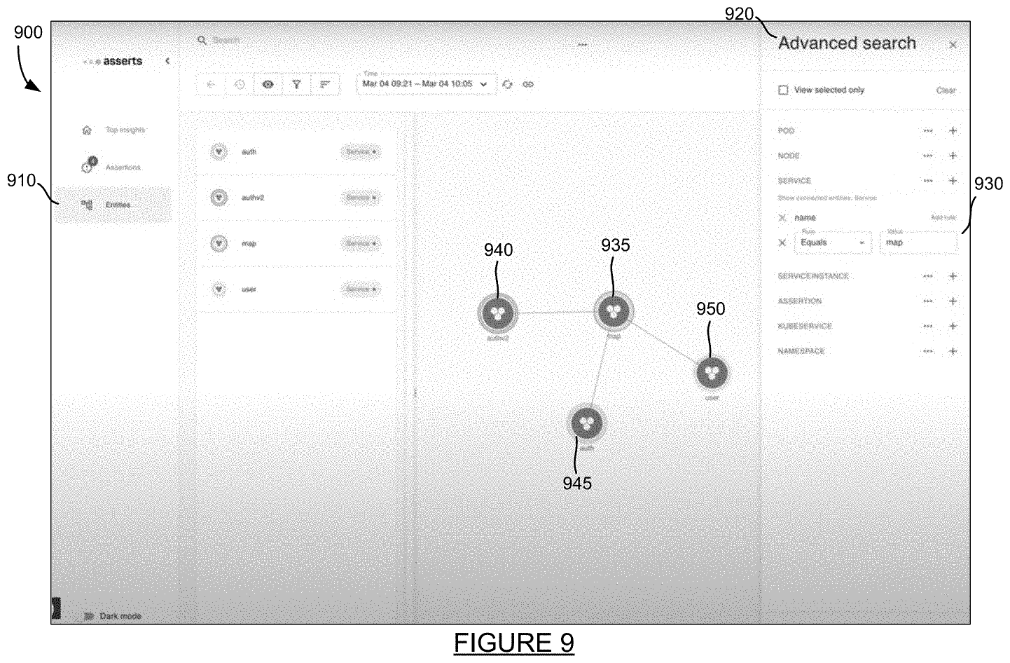

FIG. 9 illustrates a user interface for providing a node graph for selected entities within a cloud service system. Interface 900 of FIG. 9 includes a dashboard showing data for entities, and in particular an advanced search 924 four subset of nodes within a system of nodes. In the dashboard of interface 900, a search for node names associated with map are displayed, resulting in a node 935. Also displayed within the graph of interface 900 are nodes connected to the map node, which are nodes 940, 945, and 950. As shown in the dashboard of interface 900, a subset of nodes within a node system can be viewed by performing a search for the desired nodes.

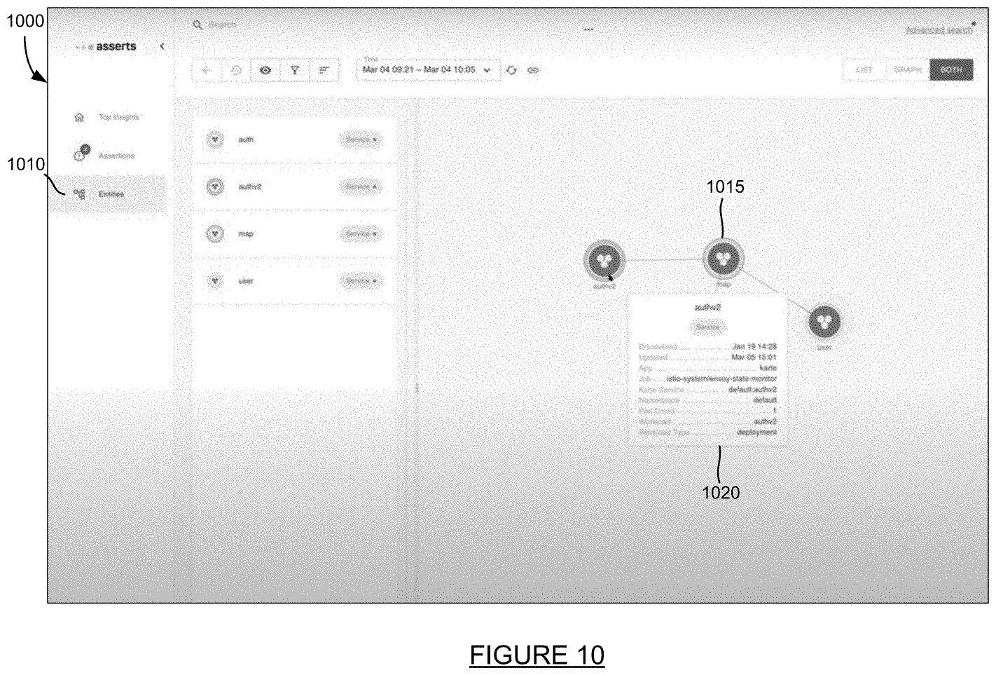

FIG. 10 illustrates properties provided for a selected node in a node graph for a monitored system. The interface 1000 of FIG. 10 illustrates a dashboard showing entities 1010. In the graph portion of the dashboard, properties 1020 are illustrated for node 1015. Properties may be shown for any node, and the properties displayed will vary based on the node type selected. For node 1015, a map service, the displayed properties include the date discovered, last update, application type, job, associated community service, the namespace, number of pods, workload, and workload type.

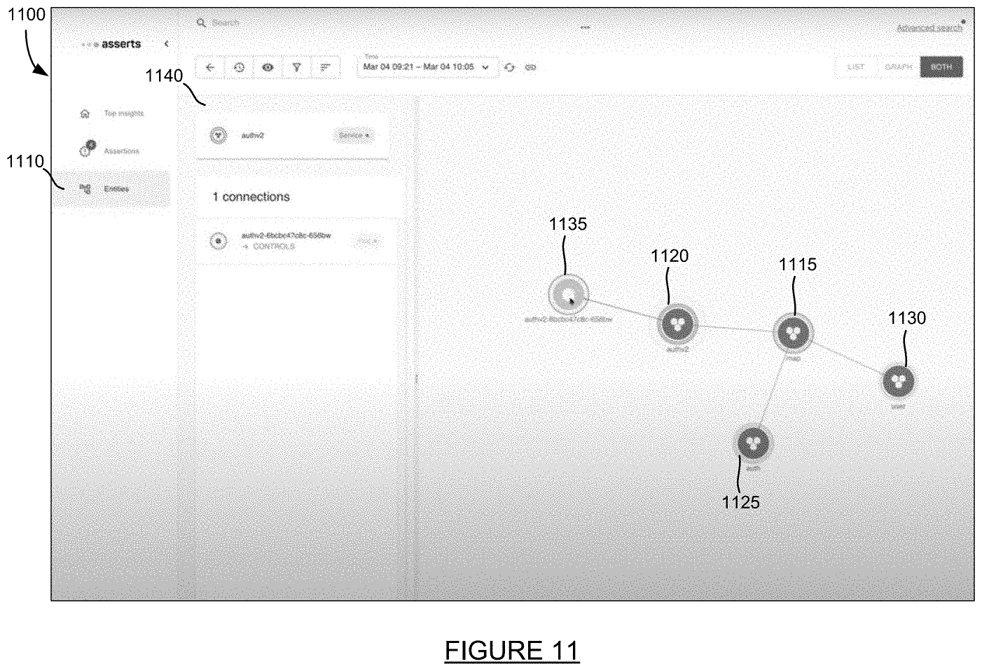

FIG. 11 illustrates an entity within a node within a node graph for a monitored system. Interface 1100 illustrates a dashboard that shows an expanded node. The node 1120 named “authv2” has two read status indicator rings around it. To view more detail for the node, the node can be selected, for example by placing a cursor over the node and receiving a click selection of the node while the cursor is over the node. Upon selection, an entity 1135 within the node may be displayed. As shown, the entity has a red ring, a yellow ring, and a name of “authv2-6bcbc47c8c-656bw.”

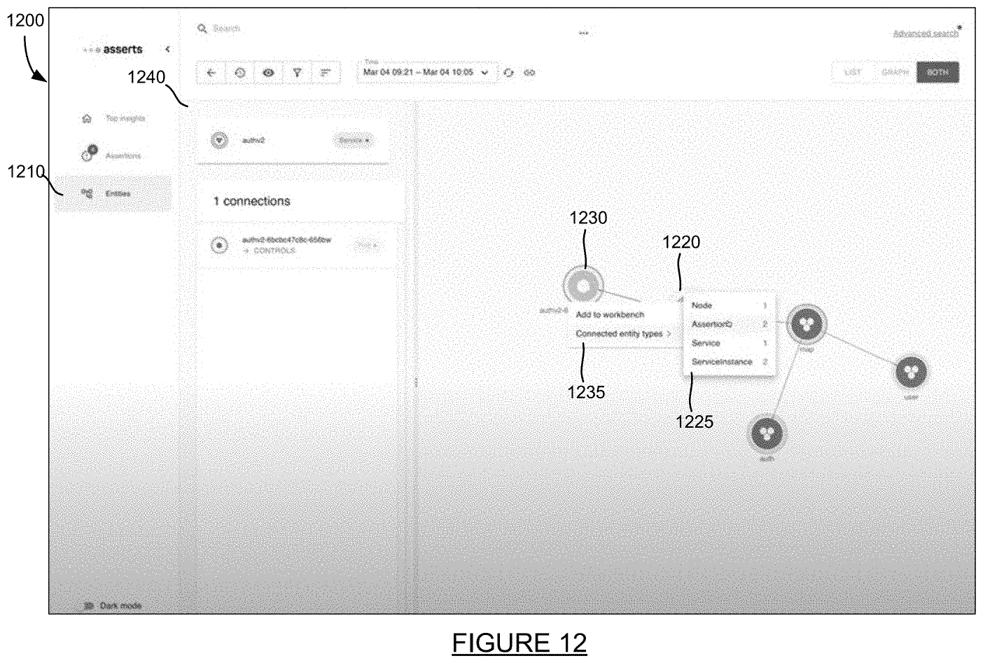

FIG. 12 illustrates a selection of additional entities for a node within a node graph for a monitored system. Interface 1200 includes a dashboard where in the pod illustrated in FIG. 11 can further be expanded. When selected, menus come up allowing user to select connected entity types of nodes, assertions, services, server instances, or other entities associated with the particular entity. In the dashboard of FIG. 12, the user is selecting connected entity types of assertions for the particular node 1230.

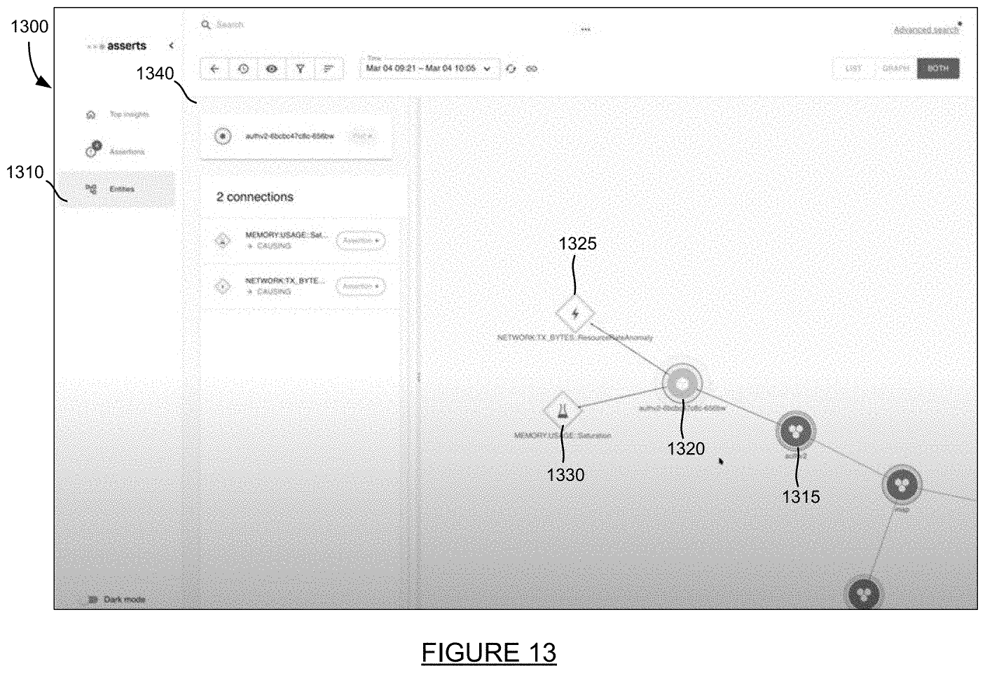

FIG. 13 illustrates assertions for entities within a node within a node graph for a monitored system. In the dashboard of interface 1300 of FIG. 13, assertions of resource rate anomaly 1325 and memory usage saturation 1330 are illustrated for the node 1320. These assertions are automatically generated for the particular node 1320, based on monitoring of the time series metric data processed by application 152.

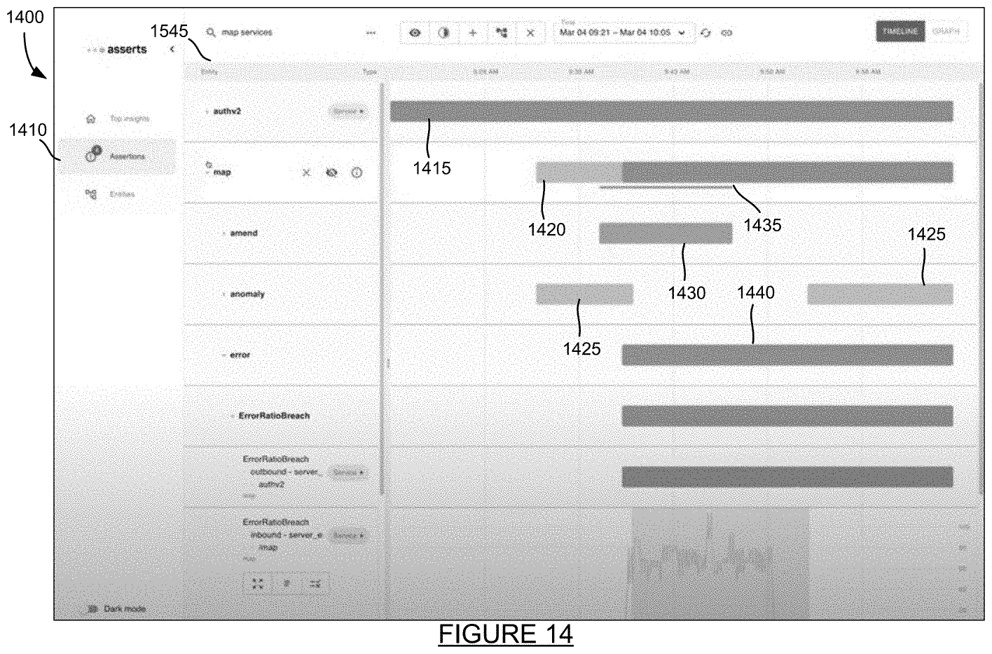

FIG. 14 illustrates a timeline for a node within a monitored system. Interface 1400 includes a dashboard where assertions 1410 are selected. For the “map” node selected at 1545, a number of timelines re provided for the assertions associated with that node. In particular, an amend assertion, anomaly assertion, and error assertion are displayed. The error assertion 1440 is red and the anomaly assertions 1425 are yellow, which are reflected in the overall timeline assertion 1420 for the node map. In this timeline view, for the node map, the assertions provided over time can be individually viewed and assessed by a user to help understand what aspects of the node are failing assertion rules and causing the particular node, in this case a service, to not operate properly.

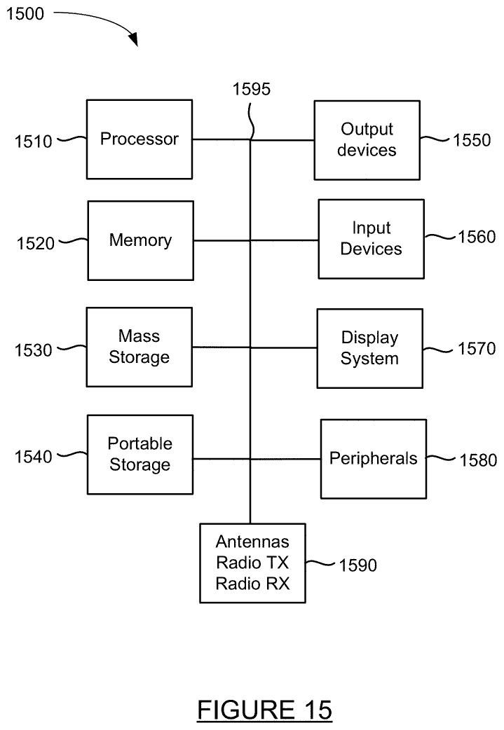

FIG. 15 is a block diagram of a system for implementing machines that implement the present technology. System 1500 of FIG. 15 may be implemented in the contexts of the likes of machines that implement applications 118, 128, and 138, client device 160, server 150, and client device 160. The computing system 1500 of FIG. 15 includes one or more processors 1510 and memory 1520. Main memory 1520 stores, in part, instructions and data for execution by processor 1510. Main memory 1520 can store the executable code when in operation. The system 1500 of FIG. 15 further includes a mass storage device 1530, portable storage medium drive(s) 1540, output devices 1550, user input devices 1560, a graphics display 1570, and peripheral devices 1580.

The components shown in FIG. 15 are depicted as being connected via a single bus 1590. However, the components may be connected through one or more data transport means. For example, processor unit 1510 and main memory 1520 may be connected via a local microprocessor bus, and the mass storage device 1530, peripheral device(s) 1580, portable storage device 1540, and display system 1570 may be connected via one or more input/output (I/O) buses.

Mass storage device 1530, which may be implemented with a magnetic disk drive, an optical disk drive, a flash drive, or other device, is a non-volatile storage device for storing data and instructions for use by processor unit 1510. Mass storage device 1530 can store the system software for implementing embodiments of the present invention for purposes of loading that software into main memory 1520.

Portable storage device 1540 operates in conjunction with a portable non-volatile storage medium, such as a floppy disk, compact disk or Digital video disc, USB drive, memory card or stick, or other portable or removable memory, to input and output data and code to and from the computer system 1500 of FIG. 15. The system software for implementing embodiments of the present invention may be stored on such a portable medium and input to the computer system 1500 via the portable storage device 1540.

Input devices 1560 provide a portion of a user interface. Input devices 1560 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1500 as shown in FIG. 15 includes output devices 1550. Examples of suitable output devices include speakers, printers, network interfaces, and monitors.

Display system 1570 may include a liquid crystal display (LCD) or other suitable display device. Display system 1570 receives textual and graphical information and processes the information for output to the display device. Display system 1570 may also receive input as a touch-screen.

Peripherals 1580 may include any type of computer support device to add additional functionality to the computer system. For example, peripheral device(s) 1580 may include a modem or a router, printer, and other device.

The system of 1500 may also include, in some implementations, antennas, radio transmitters and radio receivers 1590. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1500 of FIG. 15 are those typically found in computer systems that may be suitable for use with embodiments of the present invention and are intended to represent a broad category of such computer components that are well known in the art. Thus, the computer system 1500 of FIG. 15 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically generating and applying assertions, comprising:
receiving a first set of time series metrics with labels from one or more agents monitoring a client system in one or more computing environments;
automatically applying a set of rules to the time series metrics;
automatically updating a knowledge graph generated from the time series metrics; and
automatically generating one or more assertions based on time series metrics and the result of applying the rules, the results of applying the rules used to update the knowledge graph; and
automatically reporting the assertions though a user interface.

2. The method of claim 1, wherein an assertion is generated from one or more of saturation of a resource, an anomaly value in the metric data, a change to the software, a failure or fault, or an error rate or error budget.

3. The method of claim 1, wherein the set of rules is domain specific.

4. The method of claim 1, wherein generating the assertions includes generating graphical identifiers that indicate a rule failure.

5. The method of claim 1, wherein the first set of received metrics and labels having a universal nomenclature that is different than a native computing environment nomenclature for the metrics and labels.

6. The method of claim 1, wherein further comprising automatically identifying insights based on the one or more assertions.

7. The method of claim 1, wherein the knowledge graph includes nodes and node relationships associated with the client system.

8. The method of claim 1, further comprising automatically generating a rule configuration file based on the received first set of metrics with labels, the rule configuration file transmitted to the agent to indicate what metrics and labels the agent should subsequently retrieve from the client system, the new set of metrics retrieved by the agent based on the rule configuration file, the rule configuration file generated at least in part on the assertions.

9. A non-transitory computer readable storage medium having embodied thereon a program, the program being executable by a processor to automatically generate and apply assertions, the method comprising:
receiving a first set of time series metrics with labels from one or more agents monitoring a client system in one or more computing environments;
automatically applying a set of rules to the time series metrics;
automatically updating a knowledge graph generated from the time series metrics; and
automatically generating one or more assertions based on time series metrics and the result of applying the rules, the results of applying the rules used to update the knowledge graph; and
automatically reporting the assertions though a user interface.

10. The non-transitory computer readable storage medium of claim 9, wherein an assertion is generated from one or more of saturation of a resource, an anomaly value in the metric data, a change to the software, a failure or fault, or an error rate or error budget.

11. The non-transitory computer readable storage medium of claim 9, wherein the set of rules is domain specific.

12. The non-transitory computer readable storage medium of claim 9, wherein generating the assertions includes generating graphical identifiers that indicate a rule failure.

13. The non-transitory computer readable storage medium of claim 9, wherein the first set of received metrics and labels having a universal nomenclature that is different than a native computing environment nomenclature for the metrics and labels.

14. The non-transitory computer readable storage medium of claim 9, wherein further comprising automatically identifying insights based on the one or more assertions.

15. The non-transitory computer readable storage medium of claim 9, wherein the knowledge graph includes nodes and node relationships associated with the client system.

16. The non-transitory computer readable storage medium of claim 9, the method further comprising automatically generating a rule configuration file based on the received first set of metrics with labels, the rule configuration file transmitted to the agent to indicate what metrics and labels the agent should subsequently retrieve from the client system, the new set of metrics retrieved by the agent based on the rule configuration file, the rule configuration file generated at least in part on the assertions.

17. A system for automatically generating and applying assertions, comprising:
a server including a memory and a processor; and
one or more modules stored in the memory and executed by the processor to receiving a first set of time series metrics with labels from one or more agents monitoring a client system in one or more computing environments, automatically applying a set of rules to the time series metrics, automatically updating a knowledge graph generated from the time series metrics, automatically generating one or more assertions based on time series metrics and the result of applying the rules, the results of applying the rules used to update the knowledge graph, and automatically reporting the assertions though a user interface.

18. The system of claim 17, wherein an assertion is generated from one or more of saturation of a resource, an anomaly value in the metric data, a change to the software, a failure or fault, or an error rate or error budget.

19. The system of claim 17, wherein the set of rules is domain specific.

20. The system of claim 17, wherein generating the assertions includes generating graphical identifiers that indicate a rule failure.
